(19) United States
(12) Patent Application Publication
(10) Pub. No.: US 2004/0058150 A1
(43) Pub. Date: Mar. 25, 2004

(54) Triboluminescent materials in adhesive compositions for use in adhesive tape

(76) Inventors: Norman J Geddes, Malvern (GB); Ian C Sage, Malvern (GB); Ian R Manson, Malvern (GB); Grant H Bourhill, Gloucestershire (GB)

Correspondence Address: Nixon & Vanderhye, 8th Floor, 1100 North Glebe Road, Arlington, VA, 22201-4714, US

(21) Appl. No.: 10/467,317

(22) PCT Filed: Feb. 4, 2002
(86) PCT No.: PCT/GB02/00449

(30) Foreign Application Priority Data
Feb. 6, 2001 (GB) 01028794

(51) Int. Cl. B32B 7/12; B32B 15/04

(52) U.S. Cl. 428/343; 428/916

(57) ABSTRACT

The invention relates to the use of triboluminescent materials in paper products.

This invention relates to applications of triboluminescent materials, in particular it relates to the use of triboluminescent materials in adhesive compositions and more particularly for use in adhesive tape. This invention also relates to the use of such compositions in methods for establishing that objects have been tampered with.

Triboluminescent materials are known—(L M Sweeting & J L Guido J. of Luminescence, 33, (1985), p167, N Kitamura et al, them Phys Letts, 125, (1986), p360, B P Shandra, et al Pramana-J Phys, 29, (1987), p399, C R Hurt, et al Nature, 212, (1966), p179; L M Sweeting & A L Rheingold, J Am Chem Soc, 109, (197), p2652 M B Hocking, et al, J. of Luminescence, 43, (1989), p309). Triboluminescence is the effect seen when a material emits light when particles or the material are damaged/fractured or strained.

Currently only a limited number of applications have been disclosed utilising the triboluminescent effect. PCT GB96/02778 and corresponding, U.S. Pat. No. 5,905,260 describe the use of triboluminescent compounds in an environment where they are used to detect damage to objects. GB 2232119 discloses a security marking technique comprising the use of triboluminescent materials.

It is an objective of the present invention to find alternative uses for triboluminescent materials.

According to a first aspect of this invention an adhesive composition comprising an adhesive and one or more triboluminescent materials is provided.

Suitable triboluminescent materials may be chosen on the basis of one or more of the following characteristics:

Bright emission

Colour/wavelength of emission

High stability to temperature and high melting point

Compatibility with structural and adhesive resins

Cost of manufacture

Low toxicity

Low environmental impact

Preferably the triboluminescent materials are chosen from the following general formulae:

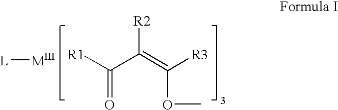

Wherein M is Eu, Tb, Dy or Sm;

R2 is H or C1-C6 alkyl or phenyl;

R1 and R3 are independently of each other selected from phenyl, H, C1-C6 alkyl;

L is p-N,N-dimethylaminopyridine, N-methylimidazole or p-methoxypyridine-N-oxide.

The C1-C6 alkyl groups can be straight chain or branched and are typically methyl, ethyl, n-propyl, isopropyl, n-butyl, sec-butyl, isobutyl, ter-butyl or the different positional isomers of pentyl and hexyl, cyclopentyl, cyclohexyl, or methyl cyclopentyl.

Preferably the alkyl groups contain 1-4 carbon atoms.

Preferably M is Eu, Tb or Dy.

R2 is preferably H.

Most preferably R1 and R3 are each tert-butyl or phenyl.

The synthesis of compounds of formula T is described in WO 96/20942 and references therein including Eisentraut et al, Inorg. Syn. 11, 1968, 94.

Other suitable compounds include:

Coumarin, phenanthrene, acenapthrene, resorcinol, m-aminophenol, aniline hydrochloride, phthalic anhydride, triphenylamine, p-anisidine, europium/terbium/manganese coordination complexes, cis-4-octene, uranyl nitrate hexahydrate, menthol, 9-anthrylmethanol [L N Sweeting & J L Guido, J. of Luminescence, 33, (1985), p167] various carbazoles [N Kitamura et al, Chem Phys Letts. 125, (1986), p360], zinc sulphide doped with luminescent impurities, uranyl nitrate, sucrose and sacharides, and the alkali halides such as sodium fluoride or lithium fluoride.

Further suitable compounds include tetrahedral manganese (II) complexes (for instance bis-triphenylphosphine oxide manganese II bromide) [B P Shandra, et al Pramana-J Phys, 29, (1987), p399]. Europium tetrakis (dibenzoylmethide)-triethylammonium [C R Hurt, et al Nature, 212, (1966), p179; L M Sweeting & A L Rheingold, J Am Chem Soc, 109,(1987), p2652] and 1,2,5-triphenylphospole [M B Hocking, et al, J. of Luminescence, 43, (1989), p309], menthyl 9-anthracene carboxylate, menthol, lithium sulphate anhydrous, saccharin, m-nitrobenzonitrile, N-acetylanthranilic acid, nicotinium salicylate, Hexaphenylcarbodiphosphorane, 9-anthrylethanol, [CH₃NH₃]₃Mn₂Cl₇

Typical Adhesives Include:

Epoxy adhesives based on adducts of bisphenol-A and epichlorhydrin cured by polyamine or anhydride initiators, and similar adhesives based on other epoxides, UV curable and thermally curable adhesives based on acrylic, vinylic, styrenic, or thiol/ene monomer systems, cyanoacrylate adhesives, pressure-sensitive adhesives, hot melt adhesives, latex based adhesives, PVA adhesives, solvent based adhesives, urea form aldehyde and melamine formaldehyde adhesives, anaerobic adhesives, bis-diallyamine derived adhesives etc.

In addition to the adhesive and triboluminescent material the adhesive composition may also comprise one or more of the following additional components such as solvents, wetting agents, flow modifiers, plasticisers, curing agents, dyes, fillers, stabilisers, anti-oxidants etc as is understood in the art. The compositions may include water as a solvent or dispersant or an organic solvent such as dichloromethane, acetone, tetrahydrofuran etc. may be present in order to ensure that the composition is homogenous and will spread well.

According to a further aspect of this invention a method or adhering two surfaces together comprises the steps of:

applying an adhesive composition to one or more surfaces and bringing the surfaces into contact such that adhesion occurs wherein the adhesive composition comprises an adhesive and one or more triboluminescent materials.

Preferably the triboluminescent materials are chosen from the following general formulae:

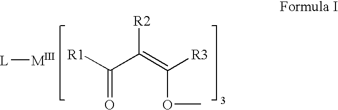

Wherein M is Eu, Tb, Dy or Sm;

R2 is H or C1-C6 alkyl or phenyl;

R1 and R3 are independently of each other selected from phenyl, H, C1-C6 alkyl;

L is p-N,N-dimethylaminopyridine, N-methylimidazole or p-methoxypyridine-N-oxide.

The C1-C6 alkyl groups can be straight chain or branched and are typically methyl, ethyl, n-propyl, isopropyl, n-butyl, sec-butyl, isobutyl, ter-butyl or the different positional isomers of pentyl and hexyl, cyclopentyl, cyclohexyl or methyl cyclopentyl.

Preferably the alkyl groups contain 1-4 carbon atoms.

Preferably M is Eu, Tb or DG.

R2 is preferably H.

Most preferably R1 and R3 are each tert-butyl or phenyl.

The synthesis of compounds of formula I is described in WO 96/20942 and references therein including Eisentraut et al, Inorg, Syn. 11, 1968, 94.

Other suitable compounds, include:

Coumarin, phenanthrene, acenaphthene, resorcinol, m-aminophenol, aniline hydrochloride, phthalic anhydride, triphenylamine, p-anisidine, europium/terbium/manganese coordination complexes, cis-4-octene, uranyl nitrate hexahydrate, menthol, 9-anthrylmethanol [L M Sweeting & J L Guido, J. of Luminescence, 33, (1985), p167] various carbazoles [N Kitamura et al, Chem Phys Letts, 125;1 (1986), p360], zinc sulphide doped with luminescent impurities, uranyl nitrate, sucrose and sacharides, and the alkali halides such as sodium fluoride or lithium fluoride.

Typical Adhesives Include

Epoxy adhesives based on adducts of bisphenol-A and epichlorhydrin cured by polyamine or anhydride initiators, and similar adhesives based on other epoxides, UV curable and thermally curable adhesives based on acrylic, vinylic, styrenic, or thiol/ene monomer systems, cyanoacrylate adhesives, pressure sensitive adhesives, hot melt adhesives, latex based adhesives, PVA adhesives, solvent based adhesives, urea formaldehyde and melamine formaldehyde adhesives, anaerobic adhesives, bis-diallyamine derived adhesives etc.

Other components of the adhesive composition may include one or more of the following additional materials such as solvents, wetting agents, flow modifiers plasticisers, curing agents, dyes, fillers etc as is understood in the art. The compositions may include water as a solvent or an organic solvent such as dichloromethane, acetone, tetrahydrofuran etc. may be present in order to ensure that the composition is homogeneous and will spread well.

According to a further aspect or this invention adhesive tape comprising an adhesive composition as given by the first aspect of the present invention is provided.

As for earlier aspects of the invention the triboluminescent material(s) present in the adhesive composition are preferably given by the following:

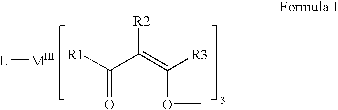

Wherein M is Eu, Tb, Dy or Sm;

R2 is H or C1-C6 alkyl or phenyl;

R1 and R3 are independently of each other selected from phenyl, H, C1-C6 alkyl;

L is p-N,N-dimethylaminopyridine, N-methylimidazole: or p-methoxypyridine-N-oxide.

The C1-C6 alkyl groups can be straight chain or branched and are typically methyl, ethyl, n-propyl, isopropyl, n-butyl, sec-butyl, isobutyl, ter-butyl or the different positional isomers of pentyl and hexyl, cyclopentyl, cyclohexyl or methyl cyclopentyl.

Preferably the alkyl groups contain 1-4 carbon atoms.

Preferably M is Eu, Tb or Dy.

R2 is preferably H.

Most preferably R1 and R3 are each tert-butyl or phenyl.

The synthesis of compounds of formula I is described in WO 96/20942 and references therein including Eisentraut el al, Inorg. Syn. 11, 1968, 94.

Other suitable compounds include:

Coumarin, phenanthrene, acenaphthene, resorcinol, m-aminophenol, aniline hydrochloride, phthalic anhydride, triphenylamine, p-anisidine, europium/terbium/manganese coordination complexes, cis-4-octene, uranyl nitrate hexahydrate, menthol, 9-anthrylmethanol [L M Sweeting & J L Guido, J. of Luminescence, 33, (1985), p167] various carbazoles [N Kitamura et al, Chem Phys Letts, 125, (1986), p360], zinc sulphide doped with luminescent impurities, uranyl nitrate, sucrose and sacharides, and the alkali halides such as sodium fluoride or lithium

Typical Adhesives Include

Epoxy adhesives based on adducts of bisphenol-A and epichlorhydrin cured by polyamine or anhydride initiators, and similar adhesives based on other epoxides, UV curable and thermally curable adhesives based on acrylic, vinylic, styrenic, or thiol/ene monomer systems, cyanoacrylate adhesives, pressure sensitive adhesives, hot melt adhesives, latex based adhesives, PVA adhesives solvent based adhesives, urea formaldehyde and melamine formaldehyde adhesives, anaerobic adhesives, bis-diallyamine derived adhesives etc.

Other components or the adhesive composition may include one or more of the following additional materials such as solvents, wetting agents, flow modifiers, plasticisers, curing agents, dyes, fillers etc as is understood in the art. The compositions may include water as a solvent or an organic solvent such as dichloromethane, acetone, tetrahydrofuran etc. may be present in order to ensure that the composition is homogenous and will spread well.

According to a further aspect of this invention method of making adhesive tape that flashes when used comprises the steps of:

selecting a substantially transparent substrate,

optionally depositing an adhesion promoter on the substrate,

depositing an adhesive composition comprising a triboluminescent material on to the substrate,

optionally drying the adhesive composition,

optionally depositing a further laminating sheet on top of the adhesive composition before or after any drying stage.

The laminating sheet, if applied, may be treated with a release layer.

By flashes whet used it is meant that the adhesive tape may flash when it is removed from a roll of adhesive tape or it may flash when it is removed from the object to which it has been applied. The adhesive tape may also flash when it is cut. How many times a particular piece of adhesive tape flashes will depend on the nature of the triboluminescent materials used and the adhesive and the substrate to which it has been adhered.

Drying may be carried out using any of the known techniques-these include:

Solvent removal, removal of a dispersant phase, chemical polymerisation or cross linking, chemical reaction or condensation and may be aided by known methods such as application of heat or UV light.

The triboluminescent materials are preferably chosen from those earlier aspects of the present invention as are the adhesives.

The substrate may comprise triboluminescent material itself, typically this would be carried out during formation of the substrate.

There are various uses to which the compositions and methods of the present invention may be put. Included are adhesive compositions when-used on envelopes and tape and the like or indicating whether or not an envelope or package has been previously opened. Alternatively, seals on containers may comprise adhesive/triboluminescent compositions according to the present invention so it is evident whether or not a container has been tampered with or damaged such that the seal has been broken in some way. For some of these particular type applications the adhesive and triboluminescent materials may with advantage be selected such that the composition only triboluminesces once.

Hence a further aspect of this invention provides a method for detecting tampering of a sealed article comprising the steps of:

coating a part of an unsealed article with an adhesive compositions,

sealing the article,

wherein the adhesive composition further comprises one or more triboluminescent materials such that on breaking the seal triboluminescence will be observed.

The article may be any type of suitable contained for example an envelope or packaging or a bottle and top.

In the above method it is also possible for the adhesive/triboluminescent mixture to be applied once the article has been sealed in some way. An example of this could be a bottle with a screw top wherein the adhesive/triboluminescent mixture could be added once the top has been screwed on to die bottle. The mixture could also be added before and after the sealing.

The adhesive composition and various other additives are as given for the first aspect of the invention.

The present invention also provides for opening packages, envelopes and the like with added aesthetic appeal. It is an objective of the present invention to provide aesthetic effects in relation to adhesives/adhesive tape through the use of technical structures and/or other technical means.

Further aspects of the invention include articles produced by the above methods.

In all of the above applications the triboluminescence is taken to be of sufficient intensity that the human eye is capable of seeing it in substantially day light and/or room lighting conditions.

According to a further aspect of this invention a triboluminescent effect may also be provided for one or more of the above applications which is capable of observation in darkened conditions or by a detecting instrument. This aspect of the invention may provide an aesthetic effect or may provide utility for example, as covert markings which authenticate an item to which they are applied or provide an anti-tampering security feature to packaging.

The invention will now be described by way of example.

A flashing form of adhesive tape according to the present invention may be fabricated as follows. An adhesive compound which may be cured via any of the known methods of curing including by uv polymerisation and a triboluminescent material are placed on to a sheet of plastic material. A further sheet of plastic is pressed on top of the first sheet, sandwiching the adhesive/triboluminescent mixture. The sheets plus mixture are then subject to curing such that the monomer polymerises-it may be the case that an amount of the monomer remains unpolymerised. In order to assess the tape the sheets may be pulled apart to reveal bright flashes.

It is not necessarily the case that the adhesive is a monomer system-any type of adhesive known to those skilled in the art would be suitable. The mixture need not necessarily require curing.

### EXAMPLE 1

Two plastic sheets in this case polyethylene terephthalate (PEF) were taken and a sample of an adhesive-compound unpolymerised Norland 65 (N65) and a uv curable monomer system with triboluminescent menthyl 9 anthracene carboxylate (M9AC) was placed on one sheet. The second sheet was taken and pressed onto the first sheet sandwiching the mixture. The two sheets were pressed closely together. The sheets were then placed into an Hereaus Suntest CPS÷ apparatus and the N65 was polymerised. Once the N65 mixture was polymerised the sheets were pulled apart. Bright flashes were observed.

### EXAMPLE 2

A triboluminescent adhesive formulation was prepared by adding Europium tetrakis (dibenzoylmethide)-triethylammonium to a solution of pressure sensitive adhesive based on poly(2-ethylhexyl acrylate-co-acrylic acid). The resulting dispersion was coated by doctor blade onto a reel of cellulose acetate tape and dried. Lengths of the resulting tape were applied under hand pressure to paper, cardboard, aluminium sheet, plastic, PET, medium density fibre board, wood. After standing for 24 hours the tape was pulled by hand from each substrate. In all cases clearly visible triboluminescent emission vas seen under room lighting.

### EXAMPLE 3

A polyethylene pharmaceutical container was sealed with an aluminised polyethylene membrane using hot melt adhesive into which was incorporated 20% by weight of terbium tris-tetramethylpentanedionate dimethylaminopyridine adduct. Removal of the seal provided a readily visible triboluminescence emission.

1. Adhesive tape comprising an adhesive-composition, wherein said adhesive composition comprises an adhesive and one or more triboluminescent materials, and said tape produces triboluminescence visible to the human eye under substantially daylight or room lighting conditions when cut or removed from a roll of such tape or an object to which it has been applied.

2. Adhesive tape according to claim 1 wherein the triboluminescent materials are chosen from the following general formulae: 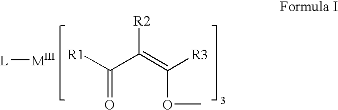
Wherein M is Eu, Tb, Dy or Sm;
R2 is H or C1-C6 alkyl or phenyl;
R1 and R3 are independently of each other selected from phenyl, H, C1-C6 alkyl;
L is p-N,N-dimethylaminopyridine, N-methylimidazole or p-methoxypyridine-N-oxide;
the C1-C6 alkyl groups can be straight chain or branched.

3. Adhesive tape according to claim 2 wherein the C1-C6 alkyl groups are selected from methyl, ethyl, n-propyl, isopropyl, n-butyl, sec-butyl, isobutyl, ter-butyl or the different positional isomers of pentyl and hexyl cyclopentyl, cyclohexyl or methyl cyclopentyl.

4. Adhesive tape according to claim 2 wherein R1 and R3 contain 1-4 carbon atoms, M is Eu, Tb or Dy, R2 contains 1-4 carbon atoms or is H.

5. Adhesive tape according to claim 4 wherein R2 is H and R1 and R3 are tert-butyl or phenyl.

6. Adhesive tape according to claim 1 wherein the triboluminescent material is chosen from M9AC, Europium tetrakis (dibenzoylmethide)-triethylammonium, terbium tris-tetramethylpentanedionate dimethylaminopyridine adduct.

7. Adhesive tape according to any of claims 1-6 wherein the adhesive is chosen from epoxy adhesives, UV curable and thermally curable adhesives based on acrylic, vinylic, styrenic, or thiol/ene monomer systems, cyanoacrylate adhesives, pressure sensitive adhesives, hot melt adhesives, latex based adhesives, PVA adhesives, solvent based adhesives, urea formaldehyde and melamine formaldehyde adhesives, anaerobic, adhesives, bis-diallyamine derived adhesives.

8. Adhesive tape according to any of claims 1-7 wherein the adhesive composition further comprises one or more of the following additional components; solvents, wetting agents, flow modifiers, plasticisers, curing agents, dyes, fillers, stabilisers, anti-oxidants.

9. Adhesive tape according to any one of claims 1 to 8 additionally comprising a substantially transparent substrate.

10. A method of making adhesive tape according to any one of claims 1 to 9 that flashes when used comprising the steps of:
selecting a substantially transparent substrate,
optionally depositing an adhesion promoter on the substrate,
depositing the adhesive composition on to the substrate,
optionally drying the adhesive composition,
optionally depositing a further laminating sheet on top of the adhesive composition before or after any drying stage.

11. A method according to claim 10 wherein the laminating sheet is applied and treated with a release layer.

12. Use of adhesive tape according to any one of claims 1 to 9 for detecting tampering of a sealed article.

13. Use according to claim 12 wherein the article is a package.

14. Use according to claim 13 wherein the package is an envelope or bottle and top.
